(19) United States
(12) Patent Application Publication
(10) Pub. No.: US 2005/0286365 A1
(43) Pub. Date: Dec. 29, 2005

(54) Initial setting of power of radiation beam for reproducing data recorded on optical information medium

(75) Inventors: Kuo-Chun Lee, Taoyuan (TW); Wan Caixia, Su Zhou City (CN)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/150,880

(22) Filed: Jun. 9, 2005

(30) Foreign Application Priority Data
Jun. 11, 2004 (TW) 093116932

(51) Int. Cl. G11B 7/00; G11B 5/09

(52) U.S. Cl. 369/47.5; 369/53.11; 369/59.11

(57) ABSTRACT

The present invention provides a method for initially setting a power of a radiation beam for reproducing data recorded on an optical information medium. The method, according to the invention, can be applied in an optical information reproducing apparatus to resolve the problems resulting from a decayed optical pick-up unit used for a long time. The method, according to the invention, can also be applied in a certain batch of optical pick-up units for adjustment thereof during assembling in the optical information reproducing apparatuses. For the batch of optical information pick-up units, the method of the invention can resolve the reduction of usability of the optical pick-up units resulting from discrepancy among the optical pick-up units, thus enhancing the yield rate of the optical pick-up units when being assembled.

### BACKGROUND OF THE INVENTION

1. Field of the Invention

The present invention provides a method for initially setting a power of a radiation beam for reproducing data recorded on an optical information recording medium. The method, according to the invention, can be applied in an optical information reproducing apparatus to resolve the problems resulting from a decayed optical pick-up unit used for a long time or to adjust gain of the level of the RF signal within a range. The method, according to the invention, can also be applied in a batch of optical pick-up units for the adjustment thereof during assembling of optical information reproducing apparatuses. For the batch of optical information pick-up units, the method of the invention can resolve the reduction of usability of the optical pick-up units resulting from variation among the optical pick-up units to enhance the yield rate of the optical pick-up units when assembled.

2. Description of the Prior Art

The optical information reproducing apparatus is a device used for playing a variety of optical disks, such as MO-disc, CD-R, CD-ROM, CD-RAM, CD-RW, DVD-R, DVD-RW, DVD+R, DVD+RW, DVD-ROM, DVD-RAM, BD (Blue Ray Disk), AOD (Advance Video Disk), HD-DVD and so on.

Typically, the initial setting of an optical information reproducing apparatus is based on a predetermined setpoint, which will be used to set the power of the radiation beam (ex. Laser Beam) of the Optical pick-up unit (OPU). The OPU will then radiate an appropriately powered beam to the optical information recording medium. Normally, the initial setpoint of the optical information reproducing apparatus is executed as a fixed voltage.

The reflected radiation beam from optical information recording medium will be detected and transformed into an electrical signal immediately, which is the so-called RF signal. Then, the data reading and servo controlling of the optical information reproducing apparatus will be based on this RF signal. In other words, the power of the radiation beam will directly affect the quality of this RF signal (Electrical Signal). If the power of the radiation beam is too weak, the correctness of the data being read and the ability of servo control of this optical information reproducing apparatus will be affected. Thus, the level of RF signal is one of the parameters that reflect the quality of the electrical signal. Also, the level of RF signal indirectly represents the strength of the reflected radiation beam. In this arrangement, the level of the RF signal is extracted from the RF signal by a low-pass filtering process, of which the output will be a DC voltage, namely the level of the RF signal. Therefore, in the initial setting of the optical information reproducing apparatus, the level of RF signal will first be multiplied by a gain value for calibration. Basically, the calibrated level of RF signal should reach a specified value in the operation.

As the noise associated with the RF signal will be amplified when the level of RF signal is multiplied by a gain value, so it doesn't seem to have much benefit to the correctness of data reading and ability of servo controlling in the optical information reproducing apparatus. For this reason, in the initial setting of the optical information reproducing apparatus, the gain value for multiplying the level of RF signal must be within an acceptable range in the calibration of the above-mentioned technique. In other words, in the initial setting of the optical information reproducing apparatus, the irradiated strength of the radiation beam must be within a reasonable range if the power of the radiation beam is set by a fixed value. The above-mentioned technique, however, will lead to some problems as described below.

The first problem emerged in the process of assembling a batch of optical pick-up units into the optical information reproducing apparatus. In this batch of optical pick-up units, there is still discrepancy among them and hence the strength of the output signals are different. The gain value of the level of the RF signal will not be measured at the time when the optical pick-up units were in the production line. Therefore, if the strength of the radiation beams were too weak, the quality of the whole product would get worse. Some of the products might be eliminated from the production line since they could not pass the quality check. Undoubtedly, this will increase the cost of production. In the past, the setting and checking procedure of optical pick-up units in the production line probably have had non-optimized product quality.

The second problem arises in the process of using the optical information reproducing apparatus. When the optical information reproducing apparatus has been used for a long time, the functioning of the internal optical pick-up unit would deteriorate. Thus, using the above-mentioned technique to calibrate the level of RF signal of the deteriorating optical pick-up units will not improve the ability and correctness of servo controlling and data reading respectively. Furthermore, there are numerous kinds of optical pick-up units nowadays; all with their own required gain value. Therefore, in order to calibrate the level of RF signal by the above-mentioned technique of the prior art to keep the efficiency of the optical information reproducing apparatus, its respective reasonable range of gain value will have to change on different kinds of optical information recording medium. The prior art, however, sets the power of optical pick-up units by using a fixed predetermined value and calibrates the level of RF signal by multiplying a gain value; this gain value may not be within the required range corresponding to a certain type of the optical information recording medium.

Consequently, the purpose of the present invention is to provide a method for initially setting a power of a radiation beam for reproducing data recorded on an optical information recording medium. Especially, based on the invention, the method can overcome the problem of reduced yielding that was caused by discrepancy of a certain batch of optical pick-up units, further improving the yield of that batch of optical pick-up units in the process of assembling. Based on the invention, additionally, the method can also be used in the optical information reproducing apparatus to overcome the problem of decay in optical pick-up unit caused by long time use.

### SUMMARY OF THE INVENTION

The present invention provides a method for initially setting a power of a radiation beam for reproducing data recorded on an optical information recording medium.

According to a first preferred embodiment of the present invention, first, the type of the optical information recording medium is detected; then, a gain value range is being login, wherein the gain range corresponds to the type of optical information recording medium. Next, a setpoint Wc is set to be equal to a predetermined value Wa, and based on the setpoint Wc, the power of the radiation beam is set to irradiate the radiation beam. Afterwards, a RF signal associated with the radiation beam is detected. Then, a gain is calculated according to the level of the RF signal and a predetermined level. Finally, the gain value is judged to see whether it falls within the gain range or beyond the gain range. If the gain value is beyond the gain range, the power of the radiation beam is re-set to irradiate the radiation beam.

According to a second preferred embodiment of the present invention, first, the type of the optical information recording medium is detected; then, a range is being login, wherein the range corresponds to the type of optical information recording medium. Next, a setpoint Wc is set to be equal to the predetermined value Wa, and based on the setpoint Wc, the power of the radiation beam is set to irradiate the radiation beam. Afterwards, a RF signal associated with the radiation beam is detected. Then, the level of the RF signal is extracted from the RF signal. Finally, the level of the RF signal is judged to see if it falls within the range or beyond the range. If the level of the RF signal is beyond the range, the power of the radiation beam is re-set to irradiate the radiation beam.

The advantage and spirit of the invention may be understood by the following recitations together with the appended drawings.

### BRIEF DESCRIPTION OF THE APPENDED DRAWINGS

FIG. 1 shows the procedure of a first preferred embodiment in the present invention.

FIG. 2 shows the procedure of a second preferred embodiment in the present invention.

### DETAILED DESCRIPTION OF THE INVENTION

The present invention provides a method for initially setting a power of a radiation beam for reproducing data recorded on an optical information recording medium. An optical pick-up unit that is within an optical information reproducing apparatus irradiates the radiation beam. The method, according to the invention, can be applied in an optical information reproducing apparatus to resolve the problems resulting from a decayed optical pick-up unit used for a long time to adjust gain of the level of the RF signal within a range. For a certain batch of optical information pick-up units, the method of the invention can also resolve the reduction of usability of the optical pick-up units resulting from discrepancy among the optical pick-up units, so as to enhance the yield rate of the optical pick-up units when they were assembled.

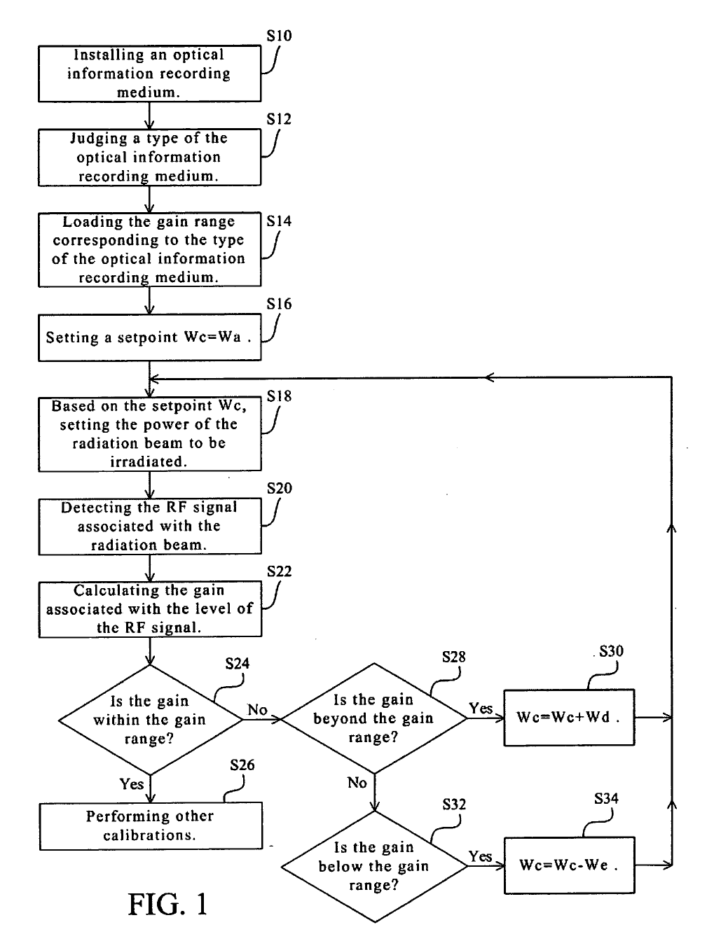

According to a first preferred embodiment of the present invention, the steps and procedure are shown in FIG. 1. First, step S10 is executed to install the optical information recording medium into the optical information reproducing apparatus. Then, step S12 is executed to detect the type of the optical information recording medium.

Then, in step S14, a gain range is being login; the gain range corresponds to the type of the optical information recording medium. In practical application, the manufacturer will measure the usable gain range of various types of optical information recording mediums in the market for constructing the corresponding graph, and the graph will be loaded into the servo of an optical information recording medium.

Then, in step S16, a setpoint Wc is set to be equal to a predetermined value Wa.

Then, in step S18, whether an optical pick-up unit of the optical information reproducing apparatus is in a customer's hand or the optical pick-up units are still in testing procedures, the radiation beam, whose power is based on the setpoint Wc, is irradiated. Then, in step S20, a RF signal associated with the radiation beam is detected. In practical application, the RF signal is the detected radiation beam that is reflected by the optical information recording medium, and it is then immediately transformed into an electrical signal.

Then, in step S22, a gain is calculated according to the level of the RF signal and a predetermined level. The gain value is used to calibrate the level of the RF signal.

In an embodiment, the level of the RF signal is extracted from the RF signal by a low-pass filtering process.

In an embodiment, the gain is calculated by the following equation:

$$gain = \frac{predetermined level}{level of RF signal}$$

After step S22, step S24 is executed, in which the calculated gain value in step S22 is judged to see whether it is within the corresponding gain range of the type of the optical information recording medium.

If YES in step S24, then, step S26 is performed to execute the other process of calibration. If NO in step S24, step S28 is performed to judge if the calculated gain value in step S22 is beyond the gain range. If YES in step S28, step S30 is performed, and the setpoint Wc is adjusted by adding a predetermined variation, for example a first predetermined variation Wd. After step S30, then step S18 is executed, in which the power of the radiation beam is re-set, based on the adjusted setpoint Wc, to irradiate the radiation beam.

If NO in step S28, step S32 is performed to judge if the calculated gain value in step S22 is under the gain range. If NO in step S32, step S34 is performed, in which the setpoint Wc is adjusted by subtracting a predetermined variation, for example a second predetermined variation We. After step S34, then step S18 is executed, in which the power of the radiation beam is re-set, based on the adjusted setpoint Wc, to irradiate the radiation beam.

In practical application, the loop of adjusting the setpoint Wc is repeated until the gain is within the gain range.

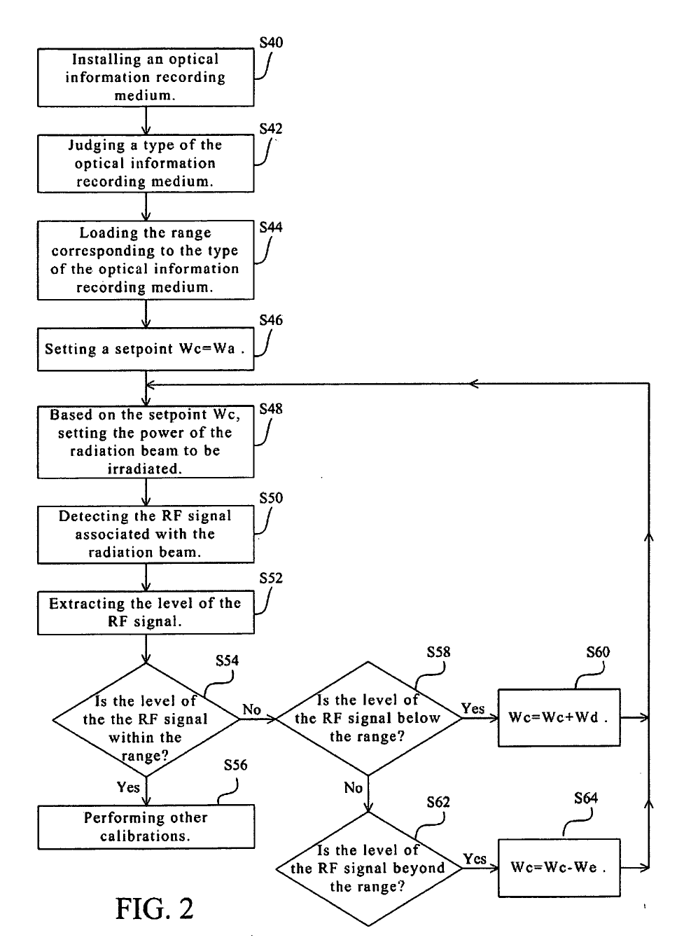

Except for judging by the gain value of the level of the RF signal, it can be judged by the level of the RF signal directly. The details of the technique of judging by the level of the RF signal will be discussed in a second preferred embodiment of the invention. According to the second preferred embodiment of the invention, the steps and procedure are shown in FIG. 2. First, in step S40, the optical information recording medium is installed into the optical information reproducing apparatus. Then, in step S42, the type of the optical information recording medium is detected.

Then, step S44 is executed, and a range is being login; the range corresponds to the type of optical information recording medium.

Then, in step S46, a setpoint Wc is set to be equal to a predetermined value Wa.

Then, in step S48, whether the optical pick-up unit of the optical information reproducing apparatus is in a customer's hand, or the optical pick-up units are still in testing procedure, the radiation beam, whose power is based on the setpoint Wc, is irradiated.

Then, in step S50, a RF signal associated with the radiation beam is detected. In practical application, the RF signal is the detected radiation beam that is reflected by the optical information recording medium, and it is then immediately transformed into an electrical signal.

Then, in step S52, the level of the RF level is extracted from the RF signal. In an embodiment, the level of the RF signal is extracted from the RF signal by a low-pass filtering process.

After step S52, step S54 is performed to judge whether the level of the RF signal is within the corresponding range of the type of optical information recording medium.

If YES in step S54, step S56 is performed to execute the other process of calibration. If NO in step S54, step S58 is performed to judge whether the calculated gain value in step S52 is below the range.

If YES in step S58, step S60 is performed to adjust the setpoint Wc by adding a predetermined variation, for example a first predetermined variation Wd. After step S60, step S48 is performed; the power of the radiation beam is re-set based on the adjusted setpoint Wc to irradiate the radiation beam. If NO in step S58, step S62 is performed to judge whether the extracted level of the RF signal value in step S62 is beyond the range. If NO in step S62, step S64 is performed, to adjust the setpoint Wc by subtracting a predetermined variation, for example a second predetermined variation We. After step S64, step S48 is performed; the power of the radiation beam is re-set based on the adjusted setpoint Wc to irradiate the radiation beam.

In practical application, the loop of adjusting the setpoint Wc is repeated until the level of the RF signal is within the range.

The summary of characteristics and advantages of the present invention is as below:

For a certain batch of optical information pick-up units, the method of adjusting the power of radiation beam based on a setpoint can resolve the reduction of usability of the optical pick-up units resulting from the discrepancy among the optical pick-up units, thus enhancing the yield rate of the optical pick-up units when being assembled.

Similarly, the method of adjusting the power of radiation beam based on a setpoint can resolve the problems resulting from a decayed optical pick-up unit used for a long time.

Furthermore, the power of the radiation beam is adjusted based on a setpoint corresponding to the type of optical information recording medium in order to improve the ability of servo controlling and correctness of data reading of the optical information reproducing apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method for initially setting a power of a radiation beam for reproducing data recorded on an optical information recording medium, said method comprising the steps of:
(a) setting a setpoint Wc equal to a predetermined value Wa, and based on the setpoint Wc, setting the power of the radiation beam to irradiate the radiation beam to the optical information recording medium;
(b) detecting a RF signal associated with the radiation beam reflected by the optical information recording medium;
(c) based on a level of the RF signal, judging if a criterion is satisfied; and
(d) if the criterion is not satisfied, re-setting the power of the radiation beam to irradiate the radiation beam.

2. The method of claim 1, wherein the level of the RF signal is extracted from the RF signal by a low-pass filtering process.

3. The method of claim 2, wherein in step (c), a gain is calculated in accordance with the level of the RF signal and a predetermined level, and the criterion is to judge whether the gain is within a gain range.

4. The method of claim 3, wherein in step (d), when the gain is beyond the gain range, the setpoint Wc is adjusted by adding a first predetermined variation Wd, and afterwards, the power of the radiation beam is re-set based on the adjusted setpoint Wc to irradiate the radiation beam, and when the gain is below the gain range, the setpoint Wc is adjusted by subtracting a second predetermined variation We, and, afterwards, the power of the radiation beam is re-set based on the adjusted setpoint Wc to irradiate the radiation beam.

5. The method of claim 3, wherein the gain is calculate by the following equation:
$$gain = \frac{predetermined level}{level of RF signal}$$

6. The method of claim 5, further comprising the step of repeating step (b) through step (d) until the gain is within the gain range.

7. The method of claim 6, wherein the gain range corresponds to a type of the optical information recording medium.

8. The method of claim 2, wherein the criterion is to judge whether the level of the RF signal is within a range.

9. The method of claim 8, wherein in step (d), when the level of the RF signal is below the range, the setpoint Wc is adjusted by adding a first predetermined variation Wd, and afterwards, the power of the radiation beam is re-set based on the adjusted setpoint Wc to irradiate the radiation beam, and when the level of the RF signal is beyond the range, the setpoint Wc is adjusted by subtracting a second predetermined variation We, and, afterwards, the power of the radiation beam is re-set based on the adjusted setpoint Wc to irradiate the radiation beam.

10. The method of claim 9, further comprising the step of repeating step (b) through step (d) until the level of the RF signal is within the range.

11. The method of claim 10, wherein the range corresponds to a type of the optical information recording medium.
